(19) United States
(12) Patent Application Publication
(10) Pub. No.: US 2025/0165798 A1
(43) Pub. Date: May 22, 2025

(54) MODEL TRAINING FOR DATASETS HAVING DATA SHIFTS

(71) Applicant: Capital One Services, LLC, McLean, VA (US)

(72) Inventors: Youbing YIN, McLean, VA (US); Joshua EDWARDS, Philadelphia, PA (US); Benjamin ENG, Silver Spring, MD (US)

(73) Assignee: Capital One Services, LLC, McLean, VA (US)

(21) Appl. No.: 18/513,060

(22) Filed: Nov. 17, 2023

(51) Int. Cl. G06N 3/094; G06N 3/0475

(52) U.S. Cl. CPC G06N 3/094; G06N 3/0475

(57) ABSTRACT

Methods and systems are described herein for facilitating model training related to data shifts. The system may detect, in a production dataset, a data shift from a training dataset used to train a machine learning model. The system may provide the training dataset and the production dataset to an adversarial network to train a first classifier and a second classifier, respectively. The system may provide synthetic data derived from the production dataset to the adversarial network to cause the first classifier and the second classifier to classify the synthetic data. Based on the classifications received from the adversarial network, the system may exclude the synthetic data from an updated training dataset for updating the machine learning model.

### BACKGROUND

Upon deployment of a machine learning model in a production environment, the machine learning model may perform poorly. This poor performance may be due, for example, to a data shift in the data relied upon by the machine learning model. For example, there may be discrepancies between the data input into a model during deployment of the model and the data used to train the model. Data shifts may be caused by changes to the underlying sources of the data, such as a change in the features, the target variable, or the relationship between features and target. In some instances, a data shift may render a model unable to accurately generate predictions for the dataset. Existing systems are limited in their ability to train models to accurately generate predictions in the event of the data shift.

### SUMMARY

Methods and systems are described herein for model training or updates related to data shifts. In particular, the methods and systems facilitate model training or updates in the event of a data shift between training datasets and production datasets. A data shift may cause a machine learning model to generate inaccurate predictions. For example, depending on the severity of the data shift, reliance on the training data may negatively impact the accuracy of predictions. However, attempts to solve this problem by training the machine learning model using only production data may be unsuccessful, for example, due to an insufficient amount of available production data. Supplementing the production data with synthetic data may also be unsuccessful, as the synthetic data may not be representative of the data shift. The use of synthetic data that is not representative of the data shift may waste compute resources and, moreover, fail to improve the accuracy of predictions.

To solve these technical problems, the methods and systems recite the use of training techniques in the event of a data shift between training datasets and production datasets. For example, using an adversarial network to classify synthetic data, the methods and systems may enable exclusion of synthetic data from training datasets that is not representative of the data shifts. By excluding synthetic data that does not represent data shifts, the methods and systems may reduce compute resource usage for model training by discarding synthetic data that does not improve the accuracy of predictions. For example, excluding synthetic data that does not represent data shifts results in smaller datasets, which may take less time to process, leading to faster training iterations. The updated or new model may reach a satisfactory performance level more quickly, saving computational resources. Less data may also have lower storage requirements, which frees up memory for other tasks. Moreover, with fewer data, model evaluation and validation cycles may be completed more quickly and may allow for more agile and rapid experimentation with different model architectures and hyperparameters. Faster evaluations may provide quicker feedback for model adjustments and improvements, and the ability to quickly test and iterate may contribute to more effective model fine-tuning and optimization. The methods and systems may additionally dynamically select training routines for training machine learning models based on data shift severity. The ability to dynamically select the most effective training routine for a machine learning model may enable more efficient use of compute resources by optimizing the training process. For example, selecting a training routine that converges more quickly may reduce the number of iterations needed and thus reduce training resources. Moreover, allocating resources dynamically based on the complexity and requirements of the training routine may prevent waste of compute resources. Accordingly, the methods and systems overcome the aforementioned technical problems as well as provide an improved mechanism for facilitating training of machine learning models in the event of data shifts.

Some embodiments involve reducing compute resource usage for model training related to data shifts by excluding, from training datasets, synthetic data that is not representative of a data shift. For example, the system may detect, in a production dataset, a data shift from a training dataset used to train a machine learning model. The system may provide the training dataset and the production dataset to a generative adversarial network including a first classifier and a second classifier. Providing the training dataset to the adversarial network may train the first classifier and providing the production dataset may train the second classifier. The system may additionally provide synthetic data (e.g., a synthetic dataset or subset thereof) derived from the production dataset to the adversarial network. This may cause the first classifier and the second classifier to classify the synthetic data. In some embodiments, the system may receive a first classification for the synthetic data from the first classifier and from the second classifier. In some embodiments, both the first classifier and the second classifier may have classified the synthetic data as a valid dataset (e.g., that would reflect the datasets on which the classifiers were respectively trained). For example, the first classifier may classify the synthetic data as belonging to the training dataset, and the second classifier may classify the synthetic data as belonging to the production dataset. These classifications may indicate that the synthetic data is not representative of the data shift (e.g., if the synthetic data cannot be labeled as both belonging to the training dataset and to the production dataset to be indicated as representative of the data shift) or should otherwise be excluded for updating the machine learning model (e.g., to avoid adding synthetic data to a supplemental dataset that would be representatively duplicative of data in the original training dataset, to avoid false positive classifications by the second classifier, etc.). In response to receiving the first classification from both the first classifier and from the second classifier, the system may exclude the synthetic data from an updated training dataset for updating the machine learning model. By doing so, the system may reduce compute resource usage for model training by discarding synthetic data that is not representative of the data shift in the production dataset. In this way, for example, computer resources are not used by the machine learning model to process such synthetic data that would otherwise negatively affect the accuracy of the machine learning model.

Some embodiments involve dynamically selecting training routines for training machine learning models based on data shift severity. In some embodiments, the system may detect, in a production dataset, a data shift from a training dataset used to train a first machine learning model. The system may provide the production dataset to a generative adversarial network to cause the generative adversarial network to generate synthetic data based on the production dataset. The system may determine that a magnitude of the data shift satisfies a first threshold and does not satisfy a second threshold. For example, the change in data may be significant enough to be considered a data shift but may not be so severe as to exceed the second threshold. The system may then perform a first training routine based on determining that the magnitude of the data shift satisfies the first threshold and does not satisfy the second threshold. The first training routine may involve training a second machine learning model using an updated dataset. For example, the first updated dataset may include the training dataset, the production dataset, and the synthetic data. The system may include the training dataset in the updated dataset due to the limited severity of the data shift. However, the system may weight the production and synthetic data more heavily than the training data in the updated dataset. The system may then replace the first machine learning model with the second machine learning model in a production environment. By doing so, the system may dynamically select training routines for training machine learning models based on data shift severity.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for facilitating creation and use of machine learning models, in accordance with one or more embodiments.

FIG. 2 illustrates an exemplary machine learning model, in accordance with one or more embodiments.

FIG. 3 illustrates a data structure storing training data and a data structure storing production data, in accordance with one or more embodiments.

FIG. 4 illustrates a data structure storing synthetic data, in accordance with one or more embodiments.

/FIG. 5 illustrates a data structure storing weighted data, in accordance with one or more embodiments.

FIG. 6 illustrates a computing device, in accordance with one or more embodiments.

FIG. 7 shows a flowchart of the process for model training related to data shifts, in accordance with one or more embodiments.

FIG. 8 shows a flowchart of the process for dynamically selecting training routines for training machine learning models, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

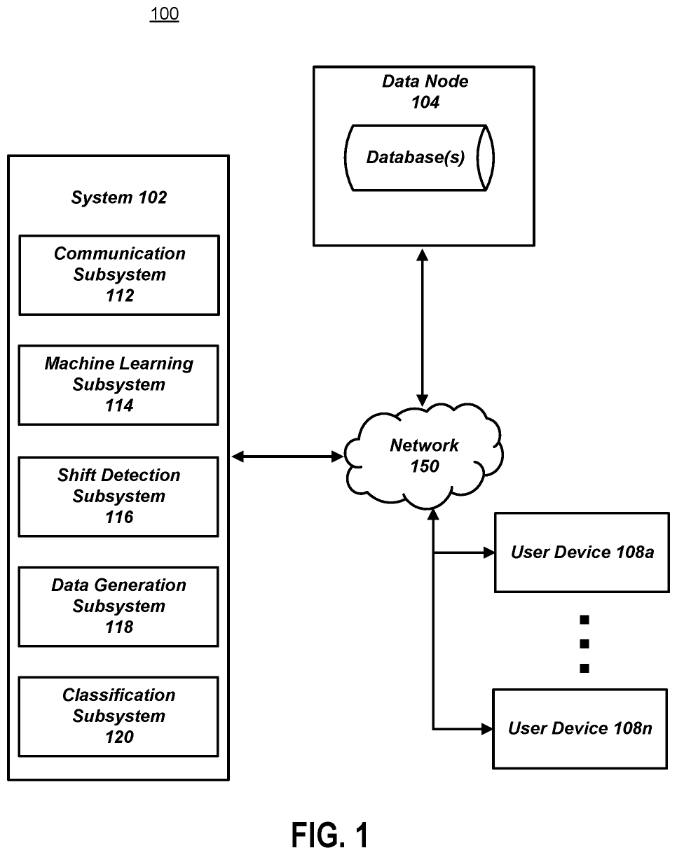

FIG. 1 shows an illustrative system 100 for facilitating creation and use of machine learning models, in accordance with one or more embodiments. In some embodiments, system 100 may train or create machine learning models to address changes in data. For example, system 100 may train or retrain machine learning models, using synthetic data, adversarial networks, dynamic training routines, and other techniques. In some embodiments, system 100 may apply certain techniques based on a severity of the data shift. As an example, for less severe data shifts, system 100 may train a machine learning model using an initial training dataset (e.g., a training dataset previously used to train the machine learning model or the currently deployed instance of the model), a production dataset, and synthetic data. System 100 may weigh the production and synthetic data more heavily than the initial training data and may discard any synthetic data that is not representative of the data shift. For more severe data shifts, system 100 may train a machine learning model using different data, such as a production dataset and synthetic data (e.g., without the initial training dataset). Again, system 100 may discard any synthetic data that is not representative of the data shift.

As an illustrative example, system 100 may train a machine learning model using a training dataset to predict program admissions for applicants based on a number of features. The data may experience a data shift between the training dataset (e.g., applicant data used to train the machine learning model) and a production dataset (e.g., applicant data used to generate predictions of program admission), for example, due to a change in admissions criteria. System 100 may train a new machine learning model using an updated training dataset. If the data shift caused by the change in admissions criteria is less severe, system 100 may use a first updated training dataset including the original training dataset, the production dataset, and synthetic data based on the production data, where the production and synthetic data are more heavily weighted than the original training data. For a more severe data shift, system 100 may use a second updated training dataset, different from the first updated training dataset, including the production dataset and the synthetic data. In some embodiments, other training routines may be used based on data shift severity. In some embodiments, the original model may be updated. System 100 may remove, from either updated training dataset, any synthetic data that does not represent the data shift. Based on the severity of the data shift, system 100 may use a first or second updated training dataset to train a new machine learning model, which may replace the original machine learning model for predicting program admissions for applicants. For example, system 100 may use the new machine learning model to predict program admissions going forward.

Some embodiments involve reducing compute resource usage for model training related to data shifts by excluding synthetic data from training datasets that is not representative of a data shift. For example, system 102 may detect, in a production dataset, a data shift from a training dataset used to train a machine learning model. System 102 may provide the training dataset and the production dataset to a generative adversarial network including a first classifier and a second classifier. Providing the training dataset to the adversarial network may train the first classifier and providing the production dataset may train the second classifier. System 102 may additionally provide synthetic data derived from the production dataset to the adversarial network. This may cause the first classifier and the second classifier to classify the synthetic data. In some embodiments, system 102 may receive a first classification for the synthetic data from the first classifier and from the second classifier. In some embodiments, the first classification may indicate that both the first classifier and the second classifier have classified the synthetic data as valid. For example, the first classification may indicate that the first classifier has classified the synthetic data as belonging to the training dataset and that the second classifier has classified the synthetic data as belonging to the production dataset. In response to receiving the first classification from both the first classifier and from the second classifier, system 102 may exclude the synthetic data from an updated training dataset for updating the machine learning model.

Some embodiments involve dynamically selecting training routines for training machine learning models based on data shift severity. In some embodiments, system 102 may detect, in a production dataset, a data shift from a training dataset used to train a first machine learning model. System 102 may provide the production dataset to a generative adversarial network to cause the generative adversarial network to generate synthetic data based on the production dataset. System 102 may determine that a magnitude of the data shift satisfies a first threshold and does not satisfy a second threshold. For example, the change in data may be severe enough to be considered a data shift but may not be so severe as to exceed the second threshold. System 102 may then perform a first training routine based on determining that the magnitude of the data shift satisfies the first threshold and does not satisfy the second threshold. The first training routine may involve training a second machine learning model using a first updated dataset. For example, the first updated dataset may include the training dataset, the production dataset, and the synthetic data. System 102 may then replace the first machine learning model with the second machine learning model in a production environment.

These processes may be used individually or in conjunction with each other and with any other processes for facilitating model training related to data shifts.

As shown in FIG. 1, system 100 may include system 102, data node 104, and user devices 108a-108n. System 102 may include communication subsystem 112, machine learning subsystem 114, shift detection subsystem 116, data generation subsystem 118, classification subsystem 120, and/or other subsystems. In some embodiments, only one user device may be used while in other embodiments multiple user devices may be used. The user devices 108a-108n may be associated with one or more users. The user devices 108a-108n may be associated with one or more user accounts. In some embodiments, user devices 108a-108n may be computing devices that may receive and send data via network 150. User devices 108a-108n may be end-user computing devices (e.g., desktop computers, laptops, electronic tablets, smartphones, and/or other computing devices used by end users). User devices 108a-108n may output (e.g., via a graphical user interface) run applications, output communications, visuals, or images, receive inputs, or perform other actions.

In some embodiments, system 102 may execute instructions for model training related to data shifts. System 102 may include software, hardware, or a combination of the two. For example, communication subsystem 112 may include a network card (e.g., a wireless network card and/or a wired network card) that is associated with software to drive the card. In some embodiments, system 102 may be a physical server or a virtual server that is running on a physical computer system. In some embodiments, system 102 may be configured on a user device (e.g., a laptop computer, a smart phone, a desktop computer, an electronic tablet, or another suitable user device).

Data node 104 may store various data, including one or more machine learning models, training data, communications, images, and/or other suitable data. In some embodiments, data node 104 may also be used to train machine learning models. Data node 104 may include software, hardware, or a combination of the two. For example, data node 104 may be a physical server or a virtual server that is running on a physical computer system. In some embodiments, system 102 and data node 104 may reside on the same hardware and/or the same virtual server/computing device. Network 150 may be a local area network, a wide area network (e.g., the internet), or a combination of the two.

System 102 (e.g., machine learning subsystem 114) may include one or more machine learning models. For example, one or more machine learning models may be trained to generate predictions based on inputs. Machine learning subsystem 114 may include software components, hardware components, or a combination of both. For example, machine learning subsystem 114 may include software components (e.g., API calls) that access one or more machine learning models. Machine learning subsystem 114 may access training data, for example, in memory. In some embodiments, machine learning subsystem 114 may access the training data on data node 104 or on user devices 108a-108n. In some embodiments, the training data may include entries with corresponding features and corresponding output labels for the entries. Machine learning subsystem 114 may access production data, for example, in memory. Production may include the stage where a machine learning model, which has been trained, is deployed and put into practical use to make predictions or decisions. Production data may include real-world data based upon which the deployed model makes predictions or decisions. This data may be distinct from training data, used to train and validate the model, and may also be distinct from test data, used to evaluate the model's performance before deployment. In some embodiments, machine learning subsystem 114 may access the production data on data node 104 or on user devices 108a-108n. In some embodiments, the production data may include entries with corresponding features and corresponding output labels for the entries. In some embodiments, machine learning subsystem 114 may access one or more machine learning models. For example, machine learning subsystem 114 may access the machine learning models on data node 104 or on user devices 108a-108n.

In some embodiments, machine learning subsystem 114 may include a generator network and a classifier (or discriminator) network. In some embodiments, machine learning subsystem 114 may utilize the adversarial network to generate synthetic data. For example, machine learning subsystem 114 may obtain a production dataset. The generator of the machine learning subsystem 114 may generate synthetic data that mimics the production data. The classifier network may include a first classifier that has been trained using the training data and a second classifier that has been trained using the production data. Both the first classifier and the second classifier may attempt to distinguish the synthetic data from the data on which the respective classifier was trained. For example, the first classifier may attempt to distinguish the synthetic data from the training data and the second classifier may attempt to distinguish the synthetic data from the production data. The generator and classifier networks may iteratively work against each other, where the generator attempts to generate synthetic data that the second classifier cannot distinguish from the production data, while the classifier attempts to accurately classify the production and synthetic data. The model's parameters may be updated based on the loss function computed during backpropagation, thus optimizing the generator and classifier networks.

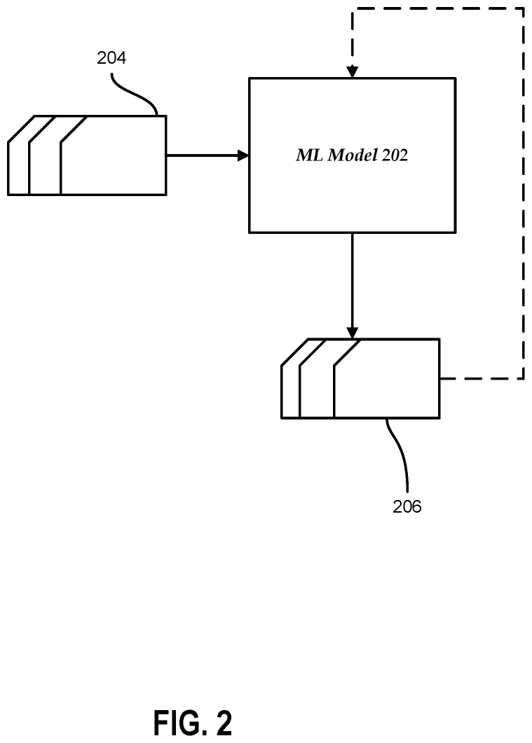

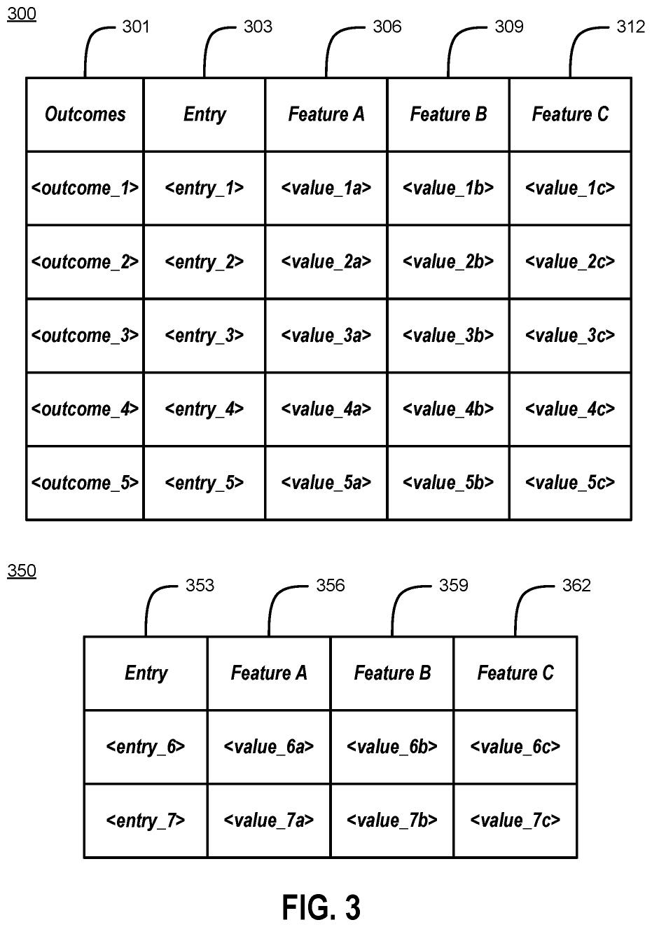

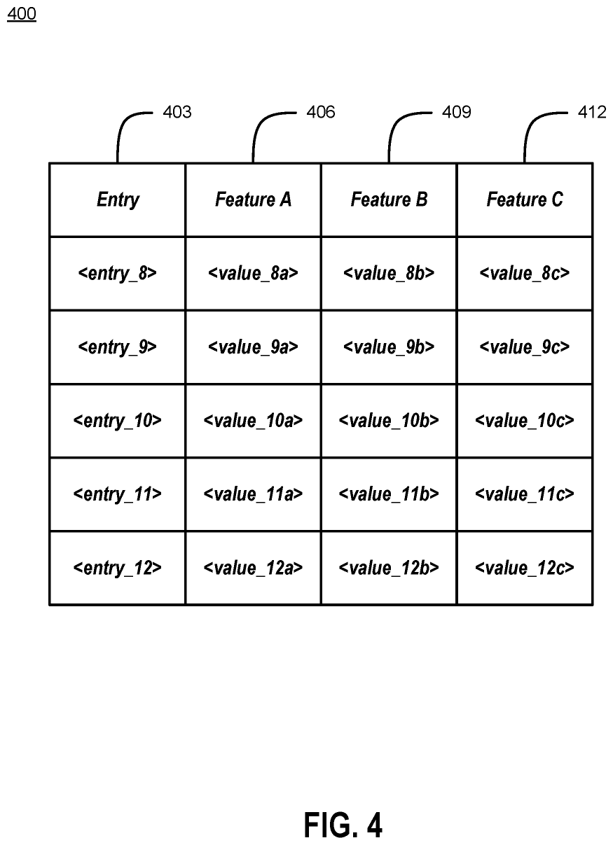

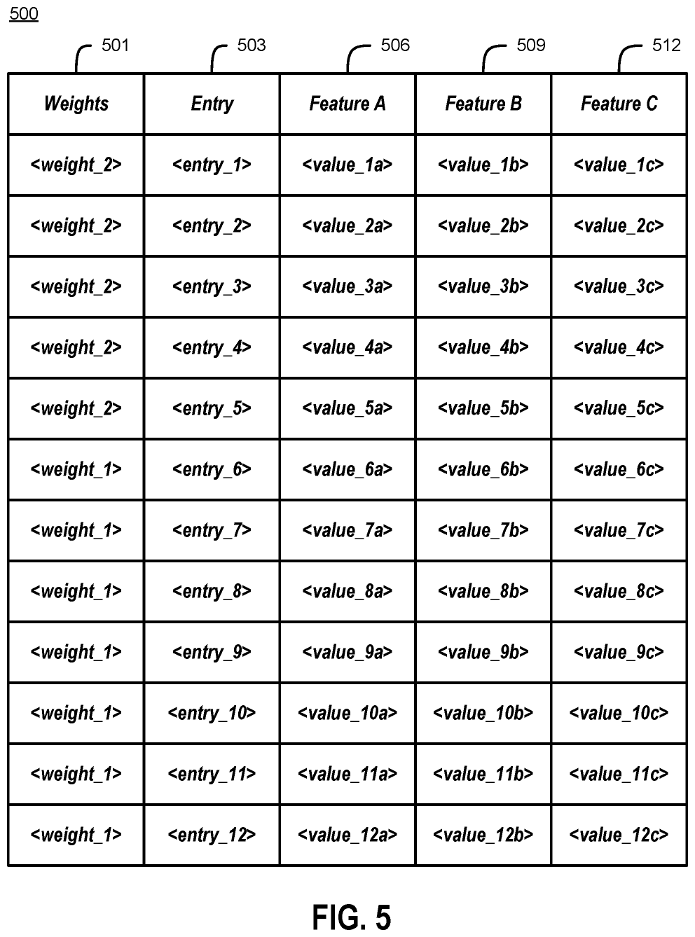

FIG. 2 illustrates an exemplary machine learning model 202, in accordance with one or more embodiments. The machine learning model may have been trained using features associated with training data. For example, training data may include features associated with one or more applicants to a particular program. In some embodiments, the machine learning model may take as inputs the features associated with each applicant. The machine learning model may have been trained to generate predictions of each applicant's acceptance into the particular program. In some embodiments, machine learning model 202 may be included in machine learning subsystem 114 or may be associated with machine learning subsystem 114. Machine learning model 202 may take input 204 (e.g., training data or production data, as discussed in greater detail in relation to FIG. 3, synthetic data, as discussed in greater detail in relation to FIG. 4, weighted data, as discussed in greater detail in relation to FIG. 5, or other inputs) and may generate outputs 206 (e.g., predictions). The output parameters may be fed back to the machine learning model as input to train the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction (e.g., of an information source) and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function, which combines the values of all of its inputs together. Each connection (or the neural unit itself) may have a threshold function that a signal must surpass before it propagates to other neural units. The machine learning model may be self-learning and/or trained, rather than explicitly programmed, and may perform significantly better in certain areas of problem solving, as compared to computer programs that do not use machine learning. During training, an output layer of the machine learning model may correspond to a classification of machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector.

The machine learning model may be structured as a factorization machine model. The machine learning model may be a non-linear model and/or a supervised learning model that can perform classification and/or regression. For example, the machine learning model may be a general-purpose supervised learning algorithm that the system uses for both classification and regression tasks. Alternatively, the machine learning model may include a Bayesian model configured to perform variational inference on the graph and/or vector.

Components of FIGS. 1 and 2 may facilitate model training related to data shifts, in accordance with embodiments discussed herein. For example, system 100 may facilitate reduction of compute resource usage for model training (e.g., training of machine learning model 202) related to data shifts by excluding synthetic data from training datasets that is not representative of the data shifts. System 100 may further facilitate dynamic selection of training routines for training machine learning models (e.g., training of machine learning model 202) based on data shift severity.

### Facilitating Model Training for Datasets Having Data Shifts

In some embodiments, system 100 may facilitate model training related to data shifts.

Some embodiments involve reducing compute resource usage for model training related to data shifts by excluding synthetic data from training datasets that is not representative of a data shift. For example, system 102 (e.g., shift detection subsystem 116) may detect, in a production dataset, a data shift from a training dataset used to train a machine learning model. Machine learning subsystem 114 may provide the training dataset and the production dataset to a generative adversarial network including a first classifier and a second classifier. Providing the training dataset to the adversarial network may train the first classifier and providing the production dataset may train the second classifier. Classification subsystem 120 may additionally provide synthetic data derived from the production dataset to the adversarial network. This may cause the first classifier and the second classifier to classify the synthetic data. In some embodiments, classification subsystem 120 may receive a first classification for the synthetic data from the first classifier and from the second classifier. In some embodiments, the first classification may indicate that both the first classifier and the second classifier have classified the synthetic data as valid. For example, the first classification may indicate that the first classifier has classified the synthetic data as belonging to the training dataset and that the second classifier has classified the synthetic data as belonging to the production dataset. These classifications may indicate that the synthetic data is not representative of the data shift (e.g., if the synthetic data cannot be labeled as both belonging to the training dataset and to the production dataset to be indicated as representative of the data shift). In response to receiving the first classification from both the first classifier and from the second classifier, machine learning subsystem 114 may exclude the synthetic data from an updated training dataset for updating the machine learning model. In some embodiments, the synthetic data may be excluded to avoid synthetic data that is not representative of the data shift, to avoid synthetic data that is representatively duplicative of data in the initial training dataset, to avoid false positive classifications by the second classifier, or for another purpose.

System 102 (e.g., shift detection subsystem 116) may detect, in a production dataset, a data shift from a training dataset used to train a machine learning model. A training dataset may be a set of data used for training machine learning models. For example, the training dataset may train a model to set parameters (i.e., weights) of a classifier, regressor, or other machine learning models. The training dataset may include input data and the corresponding correct outputs, and the model may learn to map inputs to outputs using this dataset. The training dataset may provide a model with ground truth data for learning the patterns. The algorithm iteratively makes predictions on the training data and is corrected by the feedback, leading to adjustments in the model's weights. As an example, in a machine learning model designed to predict student exam performance, the training dataset might include data such as study hours, attendance, and past performance, along with the corresponding exam scores. A production dataset may include new, unseen data that the model encounters in the real-world or operational environment after it has been deployed. A production dataset may cause the model to process the production data to make predictions or decisions in actual use. For example, once the model is deployed, it may encounter a production dataset when used to predict the exam scores of a new batch of students based on their study hours, attendance, and past performance. This production dataset is new and not part of the training dataset.

Shift detection subsystem 116 may use one or more techniques to identify a data shift, from a training dataset, in a production dataset. For example, shift detection subsystem 116 may calculate and compare summary statistics (e.g., mean, median, variance) of features in the training and production datasets. Significant differences in these statistics may indicate a data shift. Shift detection subsystem 116 may apply dimensionality reduction techniques such as Principal Component Analysis (PCA) or t-SNE to visualize high-dimensional data. Clusters forming separately for training and production data in the reduced-dimensional space may highlight data shifts. Shift detection subsystem 116 may calculate the correlation coefficients among features in the training and production datasets. A significant change in correlation patterns may hint at data shift. In some embodiments, shift detection subsystem 116 may train a classifier to distinguish between the training and production data. If the classifier performs significantly better than random guessing, it may be an indication of data shift. In some embodiments, shift detection subsystem 116 may use a combination of these or other methods to identify a data shift.

FIG. 3 illustrates a data structure 300 storing training data and a data structure 350 storing production data, in accordance with one or more embodiments. For example, data structure 300 may be a training dataset that includes entries 303 used for training a machine learning model (e.g., machine learning model 202, as shown in FIG. 2) as well as feature 306, feature 309, feature 312, or other features associated with entries 303. Outcomes 301 may be labels associated with each entry of entries 303. In some embodiments, data structure 300 may be a subset of a larger data structure including additional entries 303 or additional features. As an illustrative example, entries 303 may correspond to applicants who applied for admission to a particular program and feature 306, feature 309, feature 312, or other features may be associated with each applicant. Outcomes 301 may correspond to admissions decisions for the applicants. For example, outcomes 301 may be “yes,” which may indicate that a particular applicant was admitted, or “no,” which may indicate that a particular applicant was not admitted. In some embodiments, entries 303 may correspond to any group used to train a machine learning model to generate predictions. For example, entries 303 may correspond to customers of a company, and outcomes 301 may indicate a customer lifetime value of each person, a creditworthiness of each person, a credit limit for each person, whether each person was approved for a card, whether each person defaulted on payments, whether each person ultimately closed their account, or another outcome that the machine learning model is trained to predict. In some embodiments, entries 303 may correspond to transactions, and outcomes 301 may indicate whether transactions were fraudulent, approved, or some other outcome that the machine learning model is trained to predict.

In some embodiments, data structure 350 may be a production dataset that includes entries 353, used during deployment of a machine learning model (e.g., machine learning model 202, as shown in FIG. 2) as well as feature 356, feature 359, feature 362, or other features associated with entries 353. In some embodiments, data structure 350 may be a subset of a larger data structure including additional entries 353 or additional features. As an illustrative example, entries 353 may correspond to applicants who apply for admission to a particular program and feature 356, feature 359, feature 362, or other features may be associated with each applicant. Data structure 350 may be input into a machine learning model trained to generate admissions predictions to cause the machine learning model to output predictions for the applicants. In some embodiments, entries 353 may correspond to any group for which the machine learning model is trained to generate predictions, as discussed above.

A data shift in a production set (e.g., data structure 350) from a training dataset (e.g., data structure 300) used to train a machine learning model may include scenarios in which the statistical properties of the data in production (e.g., real-world data the model encounters after deployment) differ from those of the training dataset on which the model was trained. This difference may lead to a significant decrease in model performance because the model has learned patterns based on the training data distribution, which may not apply to the production data distribution. The data shift may include one or more of various types of data shifts, such as covariate shift, concept drift, label shift, or other types of data shift. Covariate shift may include a situation in which the distribution of the input features changes between the training and the production phases, but the conditional distribution of the output variable given the input remains the same. For example, while the inputs may look different, the relationship between inputs and outputs doesn't change in a covariate shift. As an illustrative example, a machine learning model may be trained to predict program admissions using data from students at certain high schools in which students have access to advanced coursework and extensive extracurricular activities. The model may, during deployment, shift to include applicants having access to fewer educational resources. The model may be biased toward applicants having access to more resources and opportunities, leading to unfair disadvantages for applicants having access to fewer resources and opportunities.

Concept drift may occur when the relationship between the input variables and the target variable changes over time. In concept drift, the underlying pattern or concept that the model has learned no longer holds, leading to a decrease in model performance. As an illustrative example, a model may be trained at a time when a program heavily weighs academic scores for admissions. The program may, over time, shift its focus to consider other aspects like work experience and extracurricular activities more significantly. The model, still giving more weight to academic scores, may not accurately predict admissions as the underlying concept (criteria for admission) has changed. Label shift may occur when the distribution of the output variable (or label) changes between the training and production phases, while the conditional distribution of the input given the output remains constant. For example, a model may be trained during a period when a program has many available slots, leading to a higher acceptance rate. The program may later reduce the number of available slots, causing a lower acceptance rate. As a result, the model may overestimate the probability of acceptance for applicants because it was trained on data with a higher acceptance rate. In some embodiments, a data shift between production and training datasets may include one or more of these types of data shifts or other types of data shifts.

Machine learning subsystem 114 may provide the training dataset to a first generative adversarial classifier. For example, machine learning subsystem 114 may include an adversarial network, which may include one or more generators and one or more classifiers, as discussed above in relation to FIG. 2. Providing the training dataset to the first classifier may train the first classifier to classify whether data belongs to the training dataset. Machine learning subsystem 114 may provide the production dataset to a second generative adversarial classifier. Providing the production dataset to the second classifier may train the second classifier to classify whether data belongs to a subset of the production dataset that corresponds to the data shift. For example, machine learning subsystem 114 may train the second classifier to determine whether given input data is part of a subset of the production dataset that exhibits characteristics of a data shift. For example, the subset may be a portion of the production dataset that follows a data shift and that exhibits characteristics of one or more of the types of data shifts discussed previously. In some embodiments, the subset of the production dataset may include the entire production dataset.

In some embodiments, each classifier may be trained to output a first classification or a second classification. The first classification may indicate that given input data belongs to the dataset on which the respective classifier was trained. For example, an output of the first classification from the first classifier may indicate that the given input data belongs to the training dataset. An output of the first classification from the second classifier may indicate that the given input data belongs to the subset of the production dataset that corresponds to the data shift. In some embodiments, the second classification may indicate that given input data does not belong to the dataset on which the respective classifier was trained. For example, an output of the second classification from the first classifier may indicate that the given input data does not belong to the training dataset. An output of the second classification from the second classifier may indicate that the given input data does not belong to the subset of the production dataset that corresponds to the data shift. In one scenario, where the first and second classifications correspond to binary outputs, the first classification may be the output “1,” and the second classification may be the output “0,” or vice versa.

In some embodiments, system 102 (e.g., data generation subsystem 118) may provide the production dataset to a generative adversarial generator. For example, providing the production dataset to the generator may cause the generator to generate synthetic data for potential inclusion in an updated training dataset for training the machine learning model. The generator may attempt to generate synthetic data that mimics the production data. For example, the synthetic data may maintain the same statistical properties as the production data, including mean, median, mode, variance, or other statistical measures. In some embodiments, the distributions of features in the synthetic data may closely align with the distributions in the production data. In some embodiments, the synthetic data may preserve the relationships and correlations between different variables present in the production data. The synthetic data may mimic the data types, formats, and structures present in the production data, ensuring it can be used with existing tools, systems, and processes without substantial modifications. Any observable patterns, trends, or anomalies in the production data may also be reflected in the synthetic data. In some embodiments, if the production data contains different classes (in the case of classification problems), synthetic data may maintain a similar class distribution. Synthetic data may emulate the complexity of the production data, capturing multi-dimensional relationships, non-linearity, and other intricate data characteristics. In some embodiments, the synthetic data may otherwise mimic the production data. As previously discussed in relation to FIG. 2, the generator creates synthetic data, and the discriminator evaluates the synthetic data. The feedback from the discriminator helps the generator improve the quality of the synthetic data iteratively so that the synthetic data more closely resembles the production data.

FIG. 4 illustrates a data structure 400 storing synthetic data, in accordance with one or more embodiments. In some embodiments, data structure 400 includes entries 403 as well as feature 406, feature 409, feature 412, or other features corresponding to entries 403. In some embodiments, data structure 400 may be a subset of a larger data structure including additional entries 403 or additional features. In some embodiments, the synthetic data included in data structure 400 may be generated to mimic production data (e.g., data structure 350, as shown in FIG. 3). As an illustrative example, entries 403 may correspond to applicants who apply for admission to a particular program and feature 406, feature 409, feature 412, or other features may be associated with each applicant. Data structure 400 may be input, along with production data (e.g., data structure 350), into a machine learning model trained to generate admissions predictions to cause the machine learning model to output predictions for the applicants. In some embodiments, entries 403 may correspond to any group for which the machine learning model is trained to generate predictions, as discussed above in relation to FIG. 3.

In some embodiments, machine learning subsystem 114 may train the first classifier to classify whether data belongs to the training dataset (e.g., data structure 300) and the second classifier to classify whether data belongs to the production dataset (e.g., data structure 350). Data generation subsystem 118 may generate synthetic data (e.g., data structure 400) that mimics the production data (e.g., data structure 350). System 102 (e.g., classification subsystem 120) may then provide the synthetic data (e.g., data structure 400) to the first classifier and the second classifier. In some embodiments, this may cause the first classifier and the second classifier to classify the synthetic data. For example, the first classifier may classify the synthetic data (e.g., data structure 400) as belonging to the training data (e.g., data structure 300) or not belonging to the training data. The first classifier may output a first classification to indicate that the synthetic data belongs to the dataset on which the first classifier was trained (e.g., the training dataset) or a second classification to indicate that the synthetic data does not belong to the training dataset. The second classifier may classify the synthetic data (e.g., data structure 400) as belonging to the production data (e.g., data structure 350) or not belonging to the production data. In some embodiments, the second classifier may classify whether synthetic data belongs to a subset of the production dataset that corresponds to the data shift. The second classifier may output a first classification to indicate that the synthetic data belongs to the dataset on which the first classifier was trained (e.g., the production dataset) or a second classification to indicate that the synthetic data does not belong to the production dataset or to the subset of the production dataset that corresponds to the data shift. In some embodiments, the first or second classifier may generate one or more confidence metrics to indicate a level of confidence in a classification. In some embodiments, communication subsystem 112 may output a confidence metric with each classification or communication subsystem 112 may decline to output a classification if a confidence is below a certain threshold.

For example, machine learning subsystem 114 may train a first classifier to classify synthetic data according to whether or not the synthetic data belongs to a training dataset (e.g., data structure 300), or a dataset representative of data before a data shift occurred. As an illustrative example, a training dataset may include data from students at certain high schools in which students have access to advanced coursework and extensive extracurricular activities. The first classifier may be trained to classify synthetic data as belonging or not belonging to the training dataset. For example, if synthetic data resembles data from students at certain high schools in which students have access to advanced coursework and extensive extracurricular activities, the first classifier may classify the synthetic data as belonging to the training dataset (e.g., the first classifier may output a first classification indicating that the synthetic data belongs to the training dataset). Machine learning subsystem 114 may train a second classifier to classify synthetic data according to whether or not the synthetic data belongs to a production dataset (e.g., data structure 350) or a dataset representative of data after a data shift occurred. As an illustrative example, the aforementioned model may, during deployment, shift to include applicants having access to fewer educational resources. The second classifier may be trained to classify synthetic data as belonging or not belonging to the production dataset. For example, if synthetic data resembles data from applicants having access to fewer educational resources, the second classifier may classify the synthetic data as belonging to the production dataset (e.g., the second classifier may output a first classification indicating that the synthetic data belongs to the production dataset).

In some embodiments, based on the classifications received from the classifiers, machine learning subsystem 114 may generate an updated dataset. In some embodiments, machine learning subsystem 114 may generate an updated dataset to include new data, to include additional features, or to create a more balanced dataset to improve the model's performance. Machine learning subsystem 114 may apply initial hyperparameter values for training. In some embodiments, machine learning subsystem 114 may apply one or more preprocessing steps, such as normalization, handling missing values, or encoding categorical variables, to the updated training dataset to prepare for training. Generating the updated dataset may involve merging the training dataset (e.g., data structure 300), the production dataset (e.g., data structure 350), and, if applicable, the synthetic data (e.g., data structure 400). For example, the updated training dataset may include the training dataset (e.g., data structure 300) with which the machine learning model was originally trained, new production data (e.g., data structure 350), or other data. In some embodiments, the updated training dataset may include the synthetic data (e.g., data structure 400) if, based on the classifiers, the synthetic data represents the data shift. In some embodiments, the updated training dataset may not include synthetic data generated to mimic the production data if, based on the classifiers, the synthetic data does not represent the data shift.

By excluding synthetic data that does not represent the data shift, system 102 reduces compute usage. For example, excluding synthetic data that does not represent data shifts results in smaller datasets, which may take less time to process, leading to faster training iterations. The updated or new model may reach a satisfactory performance level more quickly, saving computational resources. Less data may also have lower storage requirements, freeing up memory for other tasks. Moreover, with fewer data, model evaluation and validation cycles may be completed more quickly and may allow for more agile and rapid experimentation with different model architectures and hyperparameters. Faster evaluations may provide quicker feedback for model adjustments and improvements, and the ability to quickly test and iterate may contribute to more effective model fine-tuning and optimization.

Classification subsystem 120 may receive, from the generative adversarial network, a first classification for the synthetic data from both the first classifier and the second classifier. For example, both the first classifier and the second classifier may classify the synthetic data as belonging to the dataset on which each respective classifier was trained. The first classifier may classify the synthetic data as training data and the second classifier may classify the synthetic data as production data or as belonging to the subset of production data corresponding to the data shift. As an illustrative example, the first classifier may classify the synthetic data as resembling data from students at certain high schools in which students have access to advanced coursework and extensive extracurricular activities. The second classifier may classify the same synthetic data as resembling data from applicants having access to fewer educational resources. The incongruity of these classifications may indicate that the synthetic data does not represent the data shift (e.g., to represent the data shift, the synthetic data would resemble the production data and would not resemble the training data). Thus, in response to receiving the first classification for the synthetic data from the first classifier and from the second classifier, machine learning subsystem 114 may exclude the synthetic data from an updated training dataset for updating the machine learning model. In some embodiments, machine learning subsystem 114 may exclude a subset of the synthetic data from an updated training dataset (e.g., a subset of the synthetic data receiving the first classification from both the first and second classifiers). For example, machine learning subsystem 114 may generate an updated training dataset including the training dataset, the production dataset, or other data. In some embodiments, the updated training dataset may include some or all of the synthetic data generated by data generation subsystem 118, but in response to receiving the first classification from both the first and second classifiers, machine learning subsystem 114 may exclude some or all of the synthetic data from the updated training dataset.

In some embodiments, classification subsystem 120 may provide, to the generative adversarial network, other synthetic data derived from the production dataset. This may cause the first classifier and the second classifier to classify the other synthetic data. In some embodiments, classification subsystem 120 may receive, from the generative adversarial network, the first classification for the other synthetic data from the first classifier and a second classification for the other synthetic data from the second classifier. For example, the first classifier may classify the other synthetic data as belonging to the training dataset and the second classifier may classify the other synthetic data as not belonging to the production dataset. As an illustrative example, the first classifier may classify the synthetic data as resembling data from students at certain high schools in which students have access to advanced coursework and extensive extracurricular activities. The second classifier may classify the same synthetic data as not resembling data from applicants having access to fewer educational resources. These classifications may indicate that the synthetic data does not represent the data shift (e.g., to represent the data shift, the synthetic data would resemble the production data and would not resemble the training data). Thus, in response to receiving the first classification from the first classifier and the second classification from the second classifier, machine learning subsystem 114 may exclude the other synthetic data from the updated training dataset. In some embodiments, machine learning subsystem 114 may exclude a subset of the other synthetic data from an updated training dataset (e.g., a subset of the synthetic data receiving the first classification from the first classifier and the second classification from the second classifier).

In some embodiments, classification subsystem 120 may receive, from the generative adversarial network, a second classification for the other synthetic data from the first classifier and from the second classifier. For example, the first classifier may classify the other synthetic data as not belonging to the training dataset and the second classifier may classify the other synthetic data as not belonging to the production dataset. This may indicate that the data is not representative of the data before or after the data shift. As an illustrative example, the first classifier may classify the synthetic data as not resembling data from students at certain high schools in which students have access to advanced coursework and extensive extracurricular activities. The second classifier may classify the same synthetic data as not resembling data from applicants having access to fewer educational resources. These classifications may indicate that the synthetic data does not represent the data shift (e.g., to represent the data shift, the synthetic data would resemble the production data and would not resemble the training data). Thus, in response to receiving the second classification from the first classifier and from the second classifier, machine learning subsystem 114 may exclude the other synthetic data from the updated training dataset. In some embodiments, machine learning subsystem 114 may exclude a subset of the other synthetic data from an updated training dataset (e.g., a subset of the synthetic data receiving the second classification from the first classifier and from the second classifier).

In some embodiments, classification subsystem 120 may receive, from the generative adversarial network, a second classification for the other synthetic data from the first classifier and the first classification for the other synthetic data from the second classifier. For example, the first classifier may classify the other synthetic data as not belonging to the training dataset and the second classifier may classify the other synthetic data as belonging to the production dataset. In some embodiments, this may indicate that the other synthetic data represents the data shift. As an illustrative example, the first classifier may classify the synthetic data as not resembling data from students at certain high schools in which students have access to advanced coursework and extensive extracurricular activities. The second classifier may classify the same synthetic data as resembling data from applicants having access to fewer educational resources. These classifications may indicate that the synthetic data represents the data shift (e.g., the synthetic data resembles the production data and does not resemble the training data). Thus, in response to receiving the second classification from the first classifier and the first classification from the second classifier, machine learning subsystem 114 may include the other synthetic data in the updated training dataset. In some embodiments, machine learning subsystem 114 may include a subset of the other synthetic data from an updated training dataset (e.g., a subset of the synthetic data receiving the second classification from the first classifier and the first classification from the second classifier).

In some embodiments, machine learning subsystem 114 may, using the updated training dataset, update (e.g., retrain) the same machine learning model or train a new model. In some embodiments, machine learning subsystem 114 may update the same model or train a new model based on a severity of the data shift, which will be discussed in greater detail below. In some embodiments, machine learning subsystem 114 may update the same model or train a new model based on other criteria. Machine learning subsystem 114 may train a new machine learning model using the updated training dataset instead of or in addition to updating the existing machine learning model. In some embodiments, updating an existing model may be considerably faster and less resource intensive than training a new model from scratch.

Machine learning subsystem 114 may provide, to the machine learning model, the updated training dataset to cause the machine learning model to update. In some embodiments, machine learning subsystem 114 may use one or more techniques to update the machine learning model using the updated training dataset. For example, machine learning subsystem 114 may cause the machine learning model to update one or more weights used to generate predictions. Machine learning subsystem 114 may cause the machine learning model to update layers, learning rates, or other hyperparameters. In some embodiments, machine learning subsystem 114 may use active learning strategies to selectively update the existing machine learning model using instances from the updated training dataset that are most informative or where the machine learning model is most uncertain. In some embodiments, machine learning subsystem 114 may apply regularization techniques to avoid overfitting while updating the model on the new training dataset. In some embodiments, updating the machine learning model may include incremental learning. Incremental learning may involve continuously updating the machine learning model as new data becomes available. This method may be useful for large datasets and streaming data, where it is not practical to retrain a model from scratch. The updated training dataset may be input into the machine learning model to cause the machine learning model to update. In some embodiments, machine learning subsystem 114 may adjust a learning rate to ensure stable and effective learning as the model is updated. In some embodiments, updating the machine learning model may involve transfer learning. Transfer learning may involve reusing a pretrained model as the starting point for an updated model. For example, knowledge from the pretrained model may be transferred to a new production environment. This may involve transferring model parameters, learned features, or even entire model layers to the new environment. The transferred model may be fine-tuned in the new environment. This may be done by adjusting the model parameters, retraining some layers, or adapting the model architecture to suit the specificities of the new environment. Machine learning subsystem 114 may monitor metrics such as accuracy, precision, recall, or other metrics to ensure the model's performance does not degrade. Machine learning subsystem 114 may adjust model parameters, features, architecture, or other aspects of the model based on the evaluation results.

Machine learning subsystem 114 may update the machine learning model using the updated training dataset, in connection with detecting the data shift in the production dataset. As discussed above, the updated training dataset may include the synthetic data generated via the generative adversarial generator in certain circumstances. In some embodiments, as discussed above, the updated training dataset may exclude the synthetic data generated via the generative adversarial generator in certain circumstances. For example, machine learning subsystem 114 may update the same model that was previously trained to predict admissions to a program based on data from students at certain high schools in which students have access to advanced coursework and extensive extracurricular activities. Machine learning subsystem 114 may, using the techniques described above or other techniques, update this model to accurately predict admissions for applicants having access to fewer educational resources during deployment.

In some embodiments, machine learning subsystem 114 may provide, to a new machine learning model, the updated training dataset to train the new machine learning model to generate predictions. As discussed above, machine learning subsystem 114 may train a new machine learning model using the updated training dataset instead of or in addition to updating the existing machine learning model. Training a new model using the updated training dataset-which may include or exclude the synthetic data, as discussed above—may involve providing the updated training dataset to a new machine learning model to train the new machine learning model to generate predictions. For example, instead of updating the same model that was originally trained to predict program admissions for applicants having access to advanced coursework and extensive extracurricular activities, machine learning subsystem 114 may train a new model (e.g., from scratch) using the updated training dataset. The new model may be different from the original model and may not be previously trained or updated to generate predictions. In some embodiments, the new model may not have previously learned from a dataset. In some embodiments, the new model may have parameters that are initialized randomly or using some default configuration. As an illustrative example, the new machine learning model may not have previously been trained to predict admissions to a program. Machine learning subsystem 114 may train the new model to generate admissions predictions, for example, for applicants having access to fewer educational resources.

In some embodiments, machine learning subsystem 114 may provide, to a new machine learning model, the training dataset and the updated training dataset to train the new machine learning model to generate predictions. For example, machine learning subsystem 114 may input, into the new machine learning model, the training dataset (e.g., data structure 300) that was originally used to train the original machine learning model as well as the updated training dataset, which may include the training dataset (e.g., data structure 300), the production dataset (e.g., data structure 350), and, if applicable, synthetic data (e.g., data structure 400). In some embodiments, the updated training dataset is weighted more heavily than the training dataset. For example, machine learning subsystem 114 may weight the updated training dataset more heavily than the training dataset originally used to train the original machine learning model to cause the new machine learning model to rely more heavily on the updated training dataset than the original training dataset. For example, machine learning subsystem 114 may train a new model (e.g., from scratch) using the updated training dataset (e.g., which may include the original training dataset, production data, and, in certain circumstances, synthetic data) as well as the original training dataset, where the updated training dataset is weighted more heavily than the original training dataset.

In some embodiments, machine learning subsystem 114 may select between the aforementioned training routines for training or updating a model based on a severity of the data shift, as will be discussed in detail below. For example, machine learning subsystem 114 may select between updating a model, training a new model using a first updated training dataset (e.g., including a training dataset, a production dataset, and, in certain circumstances, synthetic data), training a new model using a second updated training dataset different from the first updated training dataset (e.g., including a production dataset and, in certain circumstances, synthetic data), or another training routine. In some embodiments, machine learning subsystem 114 may update the same model or train a new model based on other criteria or based on a combination of criteria.

As an illustrative example, system 102 may reduce compute resources for a machine learning model used to predict marketing promotion effects for credit card applications. For example, shift detection subsystem 116 may detect, in a production dataset, a data shift from a training dataset used to train a machine learning model. Shift detection subsystem 116 may detect the data shift by comparing certain metrics in relation to the training dataset and in relation to the production dataset. For example, metrics may include a view-through rate, clickthrough rate, conversion rate, abandonment rate, approval rate, activation rate, usage rate, or other metrics. Significant changes to one or more of these metrics may indicate a data shift, from the training data, in a production dataset. Machine learning subsystem 114 may provide the training dataset and the production dataset to a generative adversarial network including a first classifier and a second classifier. Providing the training dataset to the adversarial network may train the first classifier to determine whether synthetic data resembles the training data. Providing the production dataset may train the second classifier to determine whether synthetic data resembles the production data. Classification subsystem 120 may provide synthetic data derived from the production dataset to the adversarial network. In some embodiments, the synthetic data may be generated to mimic the production data (e.g., the metrics may reflect one or more of a view-through rate, clickthrough rate, conversion rate, abandonment rate, approval rate, activation rate, usage rate, or other metrics of the production dataset). In some embodiments, providing the synthetic data to the adversarial network may cause the first classifier and the second classifier to classify the synthetic data. In some embodiments, classification subsystem 120 may receive a first classification for the synthetic data from the first classifier and from the second classifier. In some embodiments, the first classification may indicate that both the first classifier and the second classifier have classified the synthetic data as valid. For example, the first classification may indicate that the first classifier has classified the synthetic data as belonging to the training dataset and that the second classifier has classified the synthetic data as belonging to the production dataset. These classifications may indicate that the synthetic data does not represent the data shift from the training dataset, and thus the synthetic data does not resemble the production data. In response to receiving the first classification from both the first classifier and from the second classifier, machine learning subsystem 114 may exclude the synthetic data from an updated training dataset for updating the machine learning model. Machine learning subsystem 114 may then train or retrain a model, using the updated training dataset, to predict marketing promotion effects.

### Dynamically Selecting Training Routines for Training Machine Learning Models Based on Data Shift Severity

In some embodiments, system 100 may facilitate dynamic selection of training routines for training machine learning models based on data shift severity.

Some embodiments involve dynamically selecting training routines for training machine learning models based on data shift severity. In some embodiments, shift detection subsystem 116 may detect, in a production dataset, a data shift from a training dataset used to train a first machine learning model. Data generation subsystem 118 may provide the production dataset to a generative adversarial network to cause the generative adversarial network to generate synthetic data based on the production dataset. Shift detection subsystem 116 may determine that a magnitude of the data shift satisfies a first threshold and does not satisfy a second threshold. For example, the change in data may be severe enough to be considered a data shift but may not be so severe as to exceed the second threshold. Machine learning subsystem 114 may then perform a first training routine based on determining that the magnitude of the data shift satisfies the first threshold and does not satisfy the second threshold. The first training routine may involve training a second machine learning model using a first updated dataset. For example, the first updated dataset may include the training dataset, the production dataset, and the synthetic data. Machine learning subsystem 114 may then replace the first machine learning model with the second machine learning model in a production environment.

Shift detection subsystem 116 may detect, in a production dataset (e.g., data structure 350, as shown in FIG. 3), a data shift from a training dataset (e.g., data structure 300, as shown in FIG. 3) used to train a machine learning model. A training dataset may be a set of data used for training machine learning models. For example, the training dataset may train a model to set parameters (i.e., weights) of a classifier, regressor, or other machine learning models. The training dataset may include input data and the corresponding correct outputs, and the model may learn to map inputs to outputs using this dataset. The training dataset may provide your model with ground truth data for learning the patterns. The algorithm iteratively makes predictions on the training data and is corrected by the feedback, leading to adjustments in the model's weights. As an example, in a machine learning model designed to predict student exam performance, the training dataset might include data such as study hours, attendance, and past performance, along with the corresponding exam scores. A production dataset may include new, unseen data that the model encounters in the real-world or operational environment after it has been deployed. A production dataset may cause the model to process the production data to make predictions or decisions in actual use. For example, once the model is deployed, it may encounter a production dataset when used to predict the exam scores of a new batch of students based on their study hours, attendance, and past performance. This production dataset is new and not part of the training dataset.

Shift detection subsystem 116 may use one or more techniques to identify a data shift, from a training dataset, in a production dataset. For example, shift detection subsystem 116 may calculate and compare summary statistics (e.g., mean, median, variance) of features in the training and production datasets. Significant differences in these statistics may indicate a data shift. Shift detection subsystem 116 may apply dimensionality reduction techniques such as PCA or t-SNE to visualize high-dimensional data. Clusters forming separately for training and production data in the reduced-dimensional space may highlight data shifts. Shift detection subsystem 116 may calculate the correlation coefficients among features in the training and production datasets. A significant change in correlation patterns may hint at data shift. In some embodiments, shift detection subsystem 116 may train a classifier to distinguish between the training and production data. If the classifier performs significantly better than random guessing, it may be an indication of data shift. In some embodiments, shift detection subsystem 116 may use a combination of these or other methods to identify a data shift.

In some embodiments, data generation subsystem 118 may provide, to a generative adversarial network, the production dataset to cause the generative adversarial network to generate synthetic data (e.g., data structure 400, as shown in FIG. 4) based on the production dataset. The generator may attempt to generate synthetic data that mimics the production data. For example, the synthetic data may maintain the same statistical properties as the production data, including mean, median, mode, variance, or other statistical measures. In some embodiments, the distributions of features in the synthetic data may closely align with the distributions in the production data. In some embodiments, the synthetic data may preserve the relationships and correlations between different variables present in the production data. The synthetic data may mimic the data types, formats, and structures present in the production data, ensuring it can be used with existing tools, systems, and processes without substantial modifications. Any observable patterns, trends, or anomalies in the production data may also be reflected in the synthetic data. In some embodiments, if the production data contains different classes (in the case of classification problems), synthetic data may maintain a similar class distribution. Synthetic data may emulate the complexity of the production data, capturing multi-dimensional relationships, non-linearity, and other intricate data characteristics. In some embodiments, the synthetic data may otherwise mimic the production data. As previously discussed in relation to FIG. 2, the generator creates synthetic data, and the discriminator evaluates the synthetic data. The feedback from the discriminator helps the generator improve the quality of the synthetic data iteratively so that the synthetic data more closely resembles the production data.

In some embodiments, shift detection subsystem 116 may calculate the magnitude of the data shift. For example, shift detection subsystem 116 may calculate the magnitude of the data shift using feature similarity scores based on the training dataset and the production dataset. For example, shift detection subsystem 116 may extract relevant features from both the training and production datasets. The features may represent the data and be comparable across both datasets. Shift detection subsystem 116 may select an appropriate similarity or distance metric (e.g., cosine similarity, Jaccard index, Euclidean distance) to compare features between the two datasets. Shift detection subsystem 116 may calculate pairwise similarity scores for each feature between the training and production datasets. A pairwise similarity score may be a measure that quantifies a degree of similarity between two features. This score may fall within a specific range (often 0 to 1), with higher values indicating greater similarity. The process of calculating pairwise similarity scores may result in a similarity matrix, where each entry represents the similarity between a pair of features (one from each dataset). A similarity matrix (e.g., a resemblance matrix) is a matrix (or two-dimensional array) that represents the pairwise similarity scores between the elements of a set. It can provide a structured format to store and analyze the relationships between items in terms of their similarity. Shift detection subsystem 116 may compute an average similarity score from the similarity matrix. The average similarity score may give an overall indication of the feature similarity between the two datasets and may represent the magnitude of the data shift.

In some embodiments, shift detection subsystem 116 may calculate the magnitude of the data shift by comparing one or more predictions generated by the first machine learning model with one or more ground truths derived from the training dataset. For example, shift detection subsystem 116 may retrieve or compute the ground truth labels or values for a subset of data from the training dataset. Ground truth labels may be actual labels or values associated with observations in a dataset. Shift detection subsystem 116 may compute the error for each prediction by comparing it with the corresponding ground truth. Shift detection subsystem 116 may use one or more types of error metrics (e.g., mean squared error for regression tasks, classification error for classification tasks) to compute the error. In some embodiments, shift detection subsystem 116 may aggregate the errors to obtain a summary statistic, such as mean error or median error. This statistic provides a single value representing the overall error between the predictions and ground truths. In some embodiments, this value may represent the magnitude of the data shift.

In some embodiments, shift detection subsystem 116 may calculate the magnitude of the data shift using one or more evaluation metrics associated with the first machine learning model. Evaluation metrics may include accuracy, precision, recall, F-1 score, area under the receiver operating characteristic curve (AUROC), confusion matrix, mean absolute error (MAE), mean squared error (MSE), root mean squared error (RMSE), coefficient of determination (r²), adjusted rand index (ARI), silhouette score, log loss, learning curve, or other evaluation metrics associated with the first machine learning model. In some embodiments, shift detection subsystem 116 may use other methods to determine the magnitude of the data shift. In some embodiments, shift detection subsystem 116 may use a combination of these or other methods to determine the magnitude of the data shift.

In some embodiments, shift detection subsystem 116 may compare the magnitude of the data shift to one or more thresholds. For example, a first threshold may represent a minimum magnitude for a data shift to be considered significant. In some embodiments, communication subsystem 112 may receive the first threshold (e.g., a predetermined threshold) or shift detection subsystem 116 may calculate the first threshold. In some embodiments, a second threshold may represent a minimum magnitude for a data shift to be considered severe. In some embodiments, communication subsystem 112 may receive the second threshold (e.g., a predetermined threshold) or shift detection subsystem 116 may calculate the second threshold. In some embodiments, shift detection subsystem 116 may receive or calculate additional thresholds. For example, shift detection subsystem 116 may determine that a severity is proportional to the magnitude of a data shift. In some embodiments, shift detection subsystem 116 may determine severity of a data shift using other techniques. In some embodiments, machine learning subsystem 114 may dynamically select training routines for training machine learning models based on comparing the magnitude of the data shift to the one or more thresholds.

In some embodiments, the training routines may involve training a second (e.g., new) machine learning model to generate predictions. Training a new machine learning model may involve machine learning subsystem 114 providing, to a new machine learning model, an updated dataset to train the new machine learning model to generate predictions. As discussed above, machine learning subsystem 114 may train a new machine learning model using the updated training dataset instead of or in addition to updating the existing (e.g., first) machine learning model. Training a new model using the updated dataset—which may include or exclude the synthetic data, as discussed above—may involve providing the updated dataset to a new machine learning model to train the new machine learning model to generate predictions. For example, instead of updating the same model that was originally trained to predict program admissions for applicants having access to advanced coursework and extensive extracurricular activities, machine learning subsystem 114 may train a new model (e.g., from scratch) using the updated dataset. The new model may be different from the original model and may not be previously trained or updated to generate predictions. In some embodiments, the new model may not have previously learned from a dataset. In some embodiments, the new model may have parameters that are initialized randomly or using some default configuration. As an illustrative example, the new machine learning model may not have previously been trained to predict admissions to a program. Machine learning subsystem 114 may train the new model to generate admissions predictions, for example, for applicants having access to fewer educational resources.

The ability to dynamically select the most effective training routine for a machine learning model may provide a more efficient use of compute resources by optimizing the training process. For example, selecting a training routine that converges faster may reduce the number of iterations and thus the training resources. Moreover, allocating resources dynamically based on the complexity and requirements of the training routine may prevent waste of compute resources. Accordingly, the methods and systems overcome the aforementioned technical problems as well as provide an improved mechanism for facilitating training of machine learning models in the event of data shifts.

For example, shift detection subsystem 116 may determine that a magnitude of the data shift does not satisfy a first threshold. In some embodiments, shift detection subsystem 116 may determine that the data shift is not significant. As an illustrative example, the change in the data (e.g., a shift from an applicant pool with many educational resources to an applicant pool with fewer educational resources) may not cause a significant data shift. Based on determining that the magnitude of the data shift does not satisfy the first threshold, machine learning subsystem 114 may refrain from performing a training routine on the first machine learning model. For example, for insignificant data shifts, the first machine learning model may continue to perform well. Thus, a machine learning subsystem 114 may not perform a training routine on the first machine learning model.

In some embodiments, machine learning subsystem 114 may compare a performance metric for the first machine learning model to a performance threshold to determine whether to perform a training routine. In some embodiments, machine learning subsystem 114 may perform one or more training routines. For example, machine learning subsystem 114 may cause the first machine learning model to update one or more weights used to generate predictions. Machine learning subsystem 114 may cause the machine learning model to update layers, learning rates, or other hyperparameters. In some embodiments, machine learning subsystem 114 may use active learning strategies to selectively update the first machine learning model using instances from the updated training dataset that are most informative or where the first machine learning model is most uncertain. In some embodiments, machine learning subsystem 114 may apply regularization techniques to avoid overfitting while updating the model on the new training dataset. In some embodiments, updating the machine learning model may include incremental learning. Incremental learning may involve continuously updating the machine learning model as new data becomes available. Updated data may be input into the first machine learning model to cause the first machine learning model to update. In some embodiments, machine learning subsystem 114 may adjust a learning rate to ensure stable and effective learning as the model is updated. In some embodiments, updating the machine learning model may involve transfer learning. Transfer learning may involve reusing a pretrained model as the starting point for an updated model. For example, knowledge from the pretrained model may be transferred to a new production environment. This may involve transferring model parameters, learned features, or even entire model layers to the new environment. The transferred model may be fine-tuned in the new environment. This may be done by adjusting the model parameters, retraining some layers, or adapting the model architecture to suit the specificities of the new environment. Machine learning subsystem 114 may monitor metrics such as accuracy, precision, recall, or other metrics to ensure the model's performance does not degrade. Machine learning subsystem 114 may adjust model parameters, features, architecture, or other aspects of the model based on the evaluation results.

In some embodiments, shift detection subsystem 116 may determine that a magnitude of the data shift satisfies a first threshold and does not satisfy a second threshold higher than the first threshold. For example, shift detection subsystem 116 may determine that the data shift is significant but is not severe. As an illustrative example, the change in the data (e.g., a shift from an applicant pool with many educational resources to an applicant pool with fewer educational resources) may cause a significant data shift of low severity. Based on determining that the magnitude of the data shift satisfies the first threshold and does not satisfy the second threshold, machine learning subsystem 114 may perform a first training routine for training a new machine learning model to generate predictions in light of the data shift. Machine learning subsystem 114 may perform the first training routine in lieu of performing a second training routine for training the new machine learning model. In some embodiments, the first training routine may involve training a second machine learning model using a first updated dataset. The first updated dataset may include the training dataset, the production dataset, and the synthetic data. In some embodiments, the first training routine may involve assigning first weights to the production dataset and the synthetic data and second weights to the training dataset, with the first weights being heavier than the second weights.

FIG. 5 illustrates a data structure 500 storing weighted data, in accordance with one or more embodiments. In some embodiments, data structure 500 includes entries 503 as well as feature 506, feature 509, feature 512, or other features corresponding to entries 503. In some embodiments, entries 503 may include training data (e.g., data that was used to train a first machine learning model, such as data structure 300, as shown in FIG. 3), production data (e.g., data structure 350, as shown in FIG. 3), synthetic data (e.g., data structure 400, as shown in FIG. 4), or other data. For example, entries 503 may include one or more of entries 303 and entries 353, as shown in FIG. 3, and entries 403, as shown in FIG. 4. In some embodiments, data structure 500 may represent a first training dataset for use in a first training routine. In some embodiments, data structure 500 may be a subset of a larger data structure including additional entries 503 or additional features. In some embodiments, data structure 500 may include weights 501. Production data and synthetic data within data structure 500 may have first weights, and training data within data structure 500 may have second weights. In some embodiments, the first weights may be heavier than the second weights. As an illustrative example, entries 503 may correspond to applicants who apply for admission to a particular program and feature 506, feature 509, feature 512, or other features may be associated with each applicant. As part of a first training routine, data structure 500 may be input into a second (e.g., new) machine learning model to train the second machine learning model to generate admissions predictions to cause the second machine learning model to output predictions for the applicants. Because of weights 501, the second machine learning model may rely on the entries 503 corresponding to production and synthetic data more heavily than the entries 503 corresponding to training data. In some embodiments, entries 503 may correspond to any group for which the machine learning model is trained to generate predictions, as discussed above in relation to FIG. 3.

Returning to FIG. 1, shift detection subsystem 116 may determine that the magnitude of the data shift satisfies the second threshold. For example, shift detection subsystem 116 may determine that the data shift is severe. As an illustrative example, the change in the data (e.g., a shift from an applicant pool with many educational resources to an applicant pool with fewer educational resources) may cause a severe data shift. In response to the magnitude of the data shift satisfying the second threshold, machine learning subsystem 114 may perform a second training routine for training the new machine learning model. In some embodiments, machine learning subsystem 114 may perform the second training routine in lieu of performing the first training routine for data shifts that are more severe. The second training routine may be different from the first training routine and may involve training the new machine learning model using a second updated dataset different from the first updated dataset. The second updated dataset may include production data and synthetic data. For example, the second updated dataset may include a production dataset (e.g., data structure 350, as shown in FIG. 3) and synthetic data (e.g., data structure 400, as shown in FIG. 4). In some embodiments, the second updated dataset may not include a training dataset that was used to train the first machine learning model (e.g., data structure 300, as shown in FIG. 3).

Once machine learning subsystem 114 has trained the second (e.g., new) machine learning model using the first training routine, the second training routine, or another training routine, machine learning subsystem 114 may replace the first machine learning model with the second (e.g., new) machine learning model in a production environment. As an illustrative example, machine learning subsystem 114 may use the second machine learning model to predict program admissions going forward. Replacing the first machine learning model with the second (e.g., new) machine learning model in a production environment may involve substituting the first model with the second (e.g., new) model. In some embodiments, replacing the first model with the second model may involve ensuring the second model is compatible with the production environment in terms of input features, data formats, dependencies, or other aspects of the production environment. In some embodiments, machine learning subsystem 114 may confirm that the second model can handle the scale of data and traffic experienced in the production environment. In some embodiments, machine learning subsystem 114 may verify that the model can return predictions within acceptable latency levels for the application. Machine learning subsystem 114 may continue to monitor the second model in the production environment to ensure that the performance of the second model is sufficient.

In some embodiments, shift detection subsystem 116 may detect a new data shift from the training dataset used to train the first machine learning model. In some embodiments, shift detection subsystem 116 may detect a new data shift from the training dataset in a new production dataset. In some embodiments, shift detection subsystem 116 may determine a new magnitude of the new data shift using one or more techniques previously discussed. Shift detection subsystem 116 may determine that a new magnitude of the new data shift satisfies the first threshold and does not satisfy the second threshold. For example, shift detection subsystem 116 may determine that the new data shift is significant but not severe. Based on determining that the new magnitude of the new data shift satisfies the first threshold and does not satisfy the second threshold, machine learning subsystem 114 may perform a third training routine. In some embodiments, the third training routine may involve obtaining an instance of the first machine learning model that has one or more same training-derived parameters as the first machine learning model previously trained using the training dataset. For example, an instance of the first machine learning model may include a specific realization of the first model, which retains certain learned parameters from the original training process. In some embodiments, an instance of the first model may include a particular application or deployment of that model in a specific context or environment. The instance may have one or more of the same training-derived parameters (e.g., internal variables that the first model learned through the training process, such as weights in a neural network) as the first model. Thus, the instance of the first model may maintain some or all of the learned knowledge from the original training process of the first model. Machine learning subsystem 114 may provide, to the instance of the first machine learning model, a second updated dataset different from the first updated dataset to generate an updated machine learning model. As discussed above, the second updated dataset may include the production dataset and the synthetic data and may not include the training dataset originally used to train the first machine learning model.

In some embodiments, generating the updated machine learning model may involve causing the first machine learning model to update one or more weights used to generate predictions. Machine learning subsystem 114 may cause the machine learning model to update layers, learning rates, or other hyperparameters. In some embodiments, generating the updated machine learning model may involve causing the first machine learning model to update one or more classifiers used to generate predictions. For example, the one or more classifiers may be responsible for categorizing an input into one of two or more categories. Updating the classifiers may involve modifying hyperparameters of the classifiers to improve performance based on ongoing monitoring and feedback. In some embodiments, machine learning subsystem 114 may adjust a learning rate to ensure stable and effective learning as the model is updated. In some embodiments, updating the machine learning model may involve transfer learning. Transfer learning may involve reusing a pretrained model as the starting point for an updated model. For example, knowledge from the pretrained model may be transferred to a new production environment. This may involve transferring model parameters, learned features, or even entire model layers to the new environment. The transferred model may be fine-tuned in the new environment. This may be done by adjusting the model parameters, retraining some layers, or adapting the model architecture to suit the specificities of the new environment. Machine learning subsystem 114 may monitor metrics such as accuracy, precision, recall, or other metrics to ensure the model's performance does not degrade. Machine learning subsystem 114 may adjust model parameters, features, architecture, or other aspects of the model based on the evaluation results.

Machine learning subsystem 114 may then replace the first machine learning model with the updated machine learning model. As an illustrative example, machine learning subsystem 114 may use the updated machine learning model to predict program admissions going forward. Replacing the first machine learning model with the updated machine learning model in a production environment may involve substituting the first model with the updated model. In some embodiments, replacing the first model with the updated model may involve ensuring the updated model is compatible with the production environment in terms of input features, data formats, dependencies, or other aspects of the production environment. In some embodiments, machine learning subsystem 114 may confirm that the updated model can handle the scale of data and traffic experienced in the production environment. In some embodiments, machine learning subsystem 114 may verify that the updated model can return predictions within acceptable latency levels for the application. Machine learning subsystem 114 may continue to monitor the updated model in the production environment to ensure that the performance of the updated model is sufficient.

As an illustrative example, system 102 may dynamically select, based on data shift severity, training routines for training machine learning models used to predict marketing promotion effects for credit card applications. In some embodiments, shift detection subsystem 116 may detect, in a production dataset, a data shift from a training dataset used to train a first machine learning model. Shift detection subsystem 116 may detect the data shift by comparing certain metrics in relation to the training dataset and in relation to the production dataset. For example, metrics may include a view-through rate, clickthrough rate, conversion rate, abandonment rate, approval rate, activation rate, usage rate, or other metrics. Significant changes to one or more of these metrics may indicate a data shift, from the training data, in a production dataset. Data generation subsystem 118 may provide the production dataset to a generative adversarial network to cause the generative adversarial network to generate synthetic data based on the production dataset. In some embodiments, the synthetic data may be generated to mimic the production data (e.g., the metrics may reflect one or more of a view-through rate, clickthrough rate, conversion rate, abandonment rate, approval rate, activation rate, usage rate, or other metrics of the production dataset). Shift detection subsystem 116 may determine that a magnitude of the data shift satisfies a first threshold and does not satisfy a second threshold. For example, the change in data may be severe enough to be considered a data shift but may not be so severe as to exceed the second threshold. Machine learning subsystem 114 may then perform a first training routine based on determining that the magnitude of the data shift satisfies the first threshold and does not satisfy the second threshold. The first training routine may involve training a second machine learning model using an updated dataset. The second machine learning model may be a new model that machine learning subsystem 114 trains from scratch using an updated dataset including the training dataset, the production dataset, and the synthetic data. Machine learning subsystem 114 may then replace the first machine learning model with the second machine learning model for predicting marketing promotion effects for credit card applications.

### Computing Environment

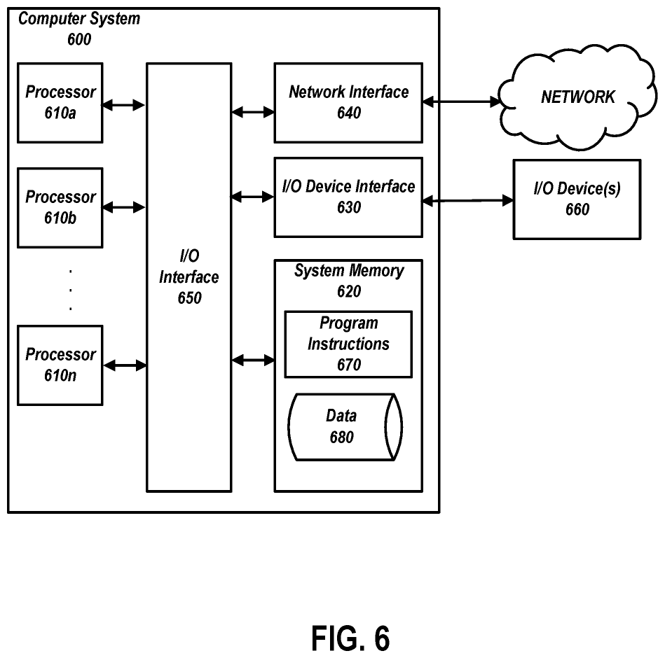

FIG. 6 shows an example computing system 600 that may be used in accordance with some embodiments of this disclosure. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, for example., an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computing system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computing system 600 through a wired or wireless connection. I/O devices 660 may be connected to computing system 600 from a remote location. I/O devices 660 located on remote computer systems, for example, may be connected to computing system 600 via a network and network interface 640.

Network interface 640 may include a network adapter that provides for connection of computing system 600 to a network. Network interface 640 may facilitate data exchange between computing system 600 and other devices connected to the network. Network interface 640 may support wired or wireless communication. The network may include an electronic communication network, such as the internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory computer-readable storage medium. A non-transitory computer-readable storage medium may include a machine-readable storage device, a machine-readable storage substrate, a memory device, or any combination thereof. A non-transitory computer-readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 600, or multiple computer systems 600 configured to host different portions or instances of embodiments. Multiple computer systems 600 may provide for parallel or sequential processing/execution of one or more portions of the techniques described herein.

Those skilled in the art will appreciate that computing system 600 is merely illustrative and is not intended to limit the scope of the techniques described herein. Computing system 600 may include any combination of devices or software that may perform or otherwise provide for the performance of the techniques described herein. For example, computing system 600 may include or be a combination of a cloud-computing system, a data center, a server rack, a server, a virtual server, a desktop computer, a laptop computer, a tablet computer, a server device, a user device, a mobile telephone, a personal digital assistant (PDA), a mobile audio or video player, a game console, a vehicle-mounted computer, a Global Positioning System (GPS), or the like. Computing system 600 may also be connected to other devices that are not illustrated or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

### Operation Flow

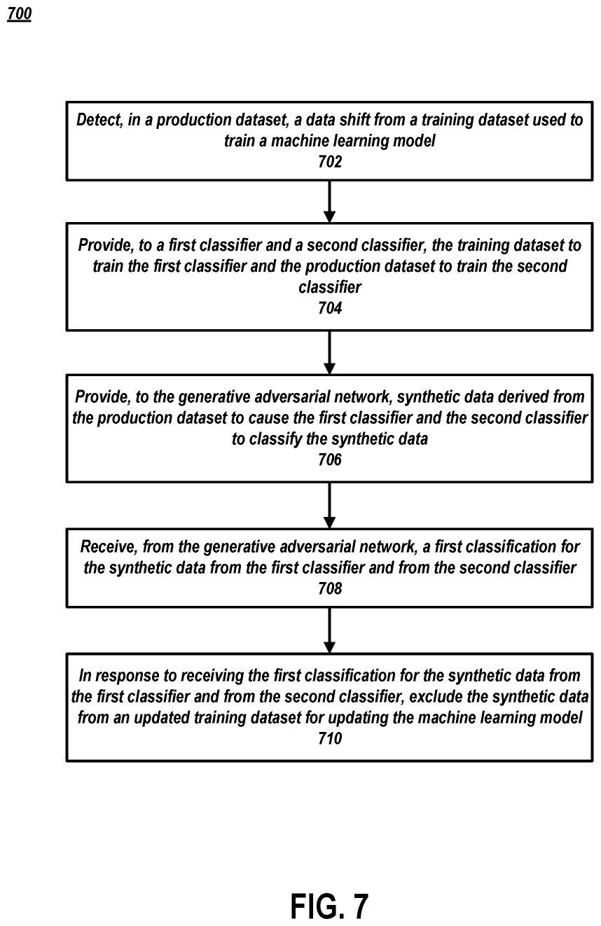

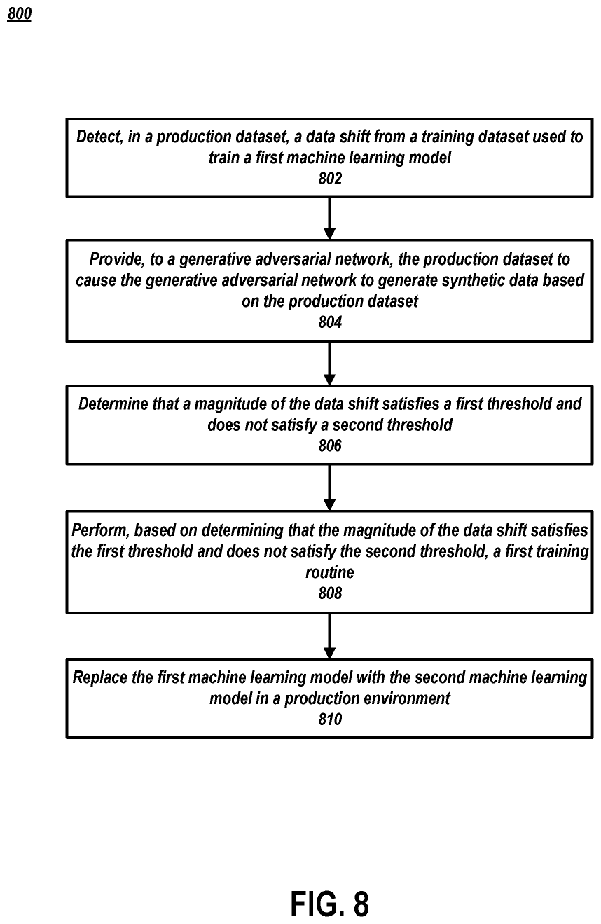

FIGS. 7-8 are example flowcharts of processing operations of methods that enable the various features and functionality of the system as described in detail above. The processing operations of each method presented below are intended to be illustrative and non-limiting. In some embodiments, for example, the methods may be accomplished with one or more additional operations not described, and/or without one or more of the operations discussed. Additionally, the order in which the processing operations of the methods are illustrated (and described below) is not intended to be limiting.

The methods may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on an electronic storage medium. The processing devices may include one or more devices configured through hardware, firmware, and/or software to be specifically designed for execution of one or more of the operations of the methods.

FIG. 7 shows a flowchart of the process 700 for model training related to data shifts, in accordance with one or more embodiments. For example, the system may use process 700 (e.g., as implemented on one or more system components described above) to reduce compute resource usage for model training related to data shifts by excluding synthetic data from training datasets that is not representative of the data shifts.

At 702, system 102 (e.g., using one or more of processors 610a-610n) may detect, in a production dataset, a data shift from a training dataset used to train a machine learning model. In some embodiments, system 102 may use one or more techniques, such as statistical analyses, data clustering, correlation coefficient comparisons, or other techniques, to detect the data shift. System 102 may detect the data shift using one or more of processors 610a-610n and may obtain the data from system memory 620 or data 680.

At 704, system 102 (e.g., using one or more of processors 610a-610n) may provide, to a generative adversarial network including a first classifier and a second classifier, the training dataset to train the first classifier and the production dataset to train the second classifier. For example, system 102 may train the first classifier to classify data as belonging to the training dataset or not belonging to the training dataset. System 102 may train the second classifier to classify data as belonging to the production dataset or not belonging to the production dataset. System 102 may train the classifiers using one or more of processors 610a-610n and may obtain the data from system memory 620 or data 680.

At 706, system 102 (e.g., using one or more of processors 610a-610n) may provide, to the generative adversarial network, synthetic data derived from the production dataset to cause the first classifier and the second classifier to classify the synthetic data. For example, the first classifier and the second classifier may indicate whether the synthetic data is representative of the training dataset or the production dataset, respectively. System 102 may provide the synthetic data to the classifiers using one or more of processors 610a-610n.

At 708, system 102 (e.g., using one or more of processors 610a-610n) may receive, from the generative adversarial network, a first classification for the synthetic data from the first classifier and from the second classifier. The first classification from each classifier may indicate that the synthetic data resembles data upon which each respective classifier was trained. For example, the first classification from the first classifier may indicate that the synthetic data resembles the training dataset and the first classification from the second classifier may indicate that the data resembles the production dataset. System 102 may receive the classifications using one or more of processors 610a-610n.

At 710, system 102 (e.g., using one or more of processors 610a-610n) may exclude the synthetic data from an updated training dataset for updating the machine learning model. System 102 may exclude the synthetic data in response to receiving the first classification for the synthetic data from the first classifier and from the second classifier. For example, the classifications indicating that the synthetic data resembles both the training dataset and the production dataset may indicate that the synthetic data is not representative of the data shift. System 102 may exclude the synthetic data using one or more of processors 610a-610n.

FIG. 8 shows a flowchart of the process 800 for dynamically selecting training routines for training machine learning models, in accordance with one or more embodiments. For example, the system may use process 800 (e.g., as implemented on one or more system components described above) to dynamically select training routines for training machine learning models based on data shift severity.

At 802, system 102 (e.g., using one or more of processors 610a-610n) may detect, in a production dataset, a data shift from a training dataset used to train a first machine learning model. In some embodiments, system 102 may use one or more techniques, such as statistical analyses, data clustering, correlation coefficient comparisons, or other techniques, to detect the data shift. System 102 may detect the data shift using one or more of processors 610a-610n and may obtain the data from system memory 620 or data 680.

At 804, system 102 (e.g., using one or more of processors 610a-610n) may provide, to a generative adversarial network, the production dataset to cause the generative adversarial network to generate synthetic data based on the production dataset. The generative adversarial network may attempt to generate synthetic data that mimics the production data. For example, the synthetic data may maintain the same statistical properties as the production data, including mean, median, mode, variance, or other statistical measures. In some embodiments, the distributions of features in the synthetic data may closely align with the distributions in the production data. In some embodiments, the synthetic data may preserve the relationships and correlations between different variables present in the production data. The synthetic data may mimic the data types, formats, and structures present in the production data, ensuring it can be used with existing tools, systems, and processes without substantial modifications. Any observable patterns, trends, or anomalies in the production data may also be reflected in the synthetic data. In some embodiments, if the production data contains different classes (in the case of classification problems), synthetic data may maintain a similar class distribution. Synthetic data may emulate the complexity of the production data, capturing multi-dimensional relationships, non-linearity, and other intricate data characteristics. System 102 may provide the production dataset to the generative adversarial network using one or more of processors 610a-610n.

At 806, system 102 (e.g., using one or more of processors 610a-610n) may determine that a magnitude of the data shift satisfies a first threshold and does not satisfy a second threshold. for example, system 102 may calculate the magnitude of the data shift and may compare the magnitude to one or more thresholds. System 102 may determine that a magnitude of the data shift satisfies a first threshold and does not satisfy a second threshold using one or more of processors 610a-610n and may receive the thresholds using network interface 640 or retrieve the thresholds from system memory 620.

At 808, system 102 (e.g., using one or more of processors 610a-610n) may perform, based on determining that the magnitude of the data shift satisfies the first threshold and does not satisfy the second threshold, a first training routine. In some embodiments, the first training routine may involve training a second machine learning model using a first updated dataset. The first updated dataset may include the training dataset, the production dataset, the synthetic data, or other data. System 102 may perform the first training routine using one or more of processors 610a-610n.

At 810, system 102 (e.g., using one or more of processors 610a-610n) may replace the first machine learning model with the second machine learning model in a production environment. For example, system 102 may use the second machine learning model to generate predictions going forward. System 102 may replace the first machine learning model with the second machine learning model using one or more of processors 610a-610n.

It is contemplated that the steps or descriptions of FIGS. 7-8 may be used with any other embodiment of this disclosure. In addition, the steps and descriptions described in relation to FIGS. 7-8 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIGS. 7-8.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

This patent application is one of a set of patent applications filed on the same day by the same applicant. These patent applications have the following titles: FACILITATING MODEL TRAINING FOR DATASETS HAVING DATA SHIFTS (Attorney Docket No. 144310.9049.US00) and DYNAMICALLY SELECTING TRAINING ROUTINES FOR TRAINING MACHINE LEARNING MODELS BASED ON DATA SHIFT SEVERITY (Attorney Docket No. 144310.9050.US00). The entire contents of each of the foregoing other patent applications is hereby incorporated by reference.

The present techniques will be better understood with reference to the following enumerated embodiments:

1. A method comprising detecting, in a second dataset, a data shift from a first dataset used to train a machine learning model, providing, to a generative adversarial network comprising a first classifier and a second classifier, the first dataset to train the first classifier and the second dataset to train the second classifier, obtaining, via the first classifier and the second classifier, a first classification of synthetic data derived from the second dataset, and in response to obtaining the first classification via the first classifier and the second classifier, excluding the synthetic data from an updated first dataset for updating the machine learning model.
2. The method of any one of the preceding embodiments, further comprising providing, to the generative adversarial network, other synthetic data derived from the second dataset to cause the first classifier and the second classifier to classify the other synthetic data, receiving, from the generative adversarial network, the first classification for the other synthetic data from the first classifier and a second classification for the other synthetic data from the second classifier, and in response to receiving the first classification from the first classifier and the second classification from the second classifier, excluding the other synthetic data from the updated first dataset.
3. The method of any one of the preceding embodiments, further comprising providing, to the generative adversarial network, other synthetic data derived from the second dataset to cause the first classifier and the second classifier to classify the other synthetic data, receiving, from the generative adversarial network, a second classification for the other synthetic data from the first classifier and the first classification for the other synthetic data from the second classifier, and in response to receiving the second classification from the first classifier and the first classification from the second classifier, including the other synthetic data in the updated first dataset.
4. The method of any one of the preceding embodiments, further comprising providing, to the generative adversarial network, other synthetic data derived from the second dataset to cause the first classifier and the second classifier to classify the other synthetic data, receiving, from the generative adversarial network, a second classification for the other synthetic data from the first classifier and from the second classifier, and in response to receiving the second classification from the first classifier and from the second classifier, excluding the other synthetic data from the updated first dataset.
5. The method of any one of the preceding embodiments, further comprising providing, to the machine learning model, the updated first dataset to cause the machine learning model to update.
6. The method of any one of the preceding embodiments, wherein causing the machine learning model to update comprises causing the machine learning model to update one or more weights used to generate predictions.
7. The method of any one of the preceding embodiments, further comprising providing, to a new machine learning model, the updated first dataset to train the new machine learning model to generate predictions.
8. The method of any one of the preceding embodiments, further comprising providing, to a new machine learning model, the first dataset and the updated first dataset to train the new machine learning model to generate predictions, wherein the updated first dataset is weighted more heavily than the first dataset.
9. The method of any one of the preceding embodiments, wherein the first classification from a classifier indicates that the synthetic data belongs to a dataset on which the classifier is trained and a second classification from the classifier indicates that the synthetic data does not belong to the dataset on which the classifier is trained.
10. The method of any one of the preceding embodiments, further comprising providing, to the generative adversarial network, the second dataset to cause the generative adversarial network to derive the synthetic data from the second dataset.
11. A method comprising detecting, in a second dataset, a data shift from a first dataset used to train a first machine learning model, obtaining, via a generative adversarial network, synthetic data based on the second dataset, performing, based on a magnitude of the data shift satisfying a first threshold and not satisfying a second threshold, a first training routine comprising training a second machine learning model using the first dataset, the second dataset, and the synthetic data, and replacing the first machine learning model with the second machine learning model.
12. The method of any one of the preceding embodiments, further comprising detecting, in a new second dataset, a new data shift from the first dataset used to train the first machine learning model, determining that a new magnitude of the new data shift satisfies the second threshold, performing, based on determining that the new magnitude of the new data shift satisfies the second threshold, a second training routine comprising training a new machine learning model using a second updated dataset different from the first updated dataset, the second updated dataset comprising the second dataset and the synthetic data, and replacing the first machine learning model with the new machine learning model.
13. The method of any one of the preceding embodiments, further comprising detecting, in a new second dataset, a new data shift from the first dataset used to train the first machine learning model, determining that a new magnitude of the new data shift satisfies the first threshold and does not satisfy the second threshold, performing, based on determining that the new magnitude of the new data shift satisfies the first threshold and does not satisfy the second threshold, a third training routine comprising (i) obtaining an instance of the first machine learning model that has one or more same training-derived parameters as the first machine learning model previously trained using the first dataset and (ii) providing, to the instance of the first machine learning model, a second updated dataset different from the first updated dataset to generate an updated machine learning model, the second updated dataset comprising the second dataset and the synthetic data, and replacing the first machine learning model with the updated machine learning model.
14. The method of any one of the preceding embodiments, wherein generating the updated machine learning model comprises causing the first machine learning model to update one or more weights used to generate predictions.
15. The method of any one of the preceding embodiments, wherein generating the updated machine learning model comprises causing the first machine learning model to update one or more classifiers used to generate predictions.
16. The method of any one of the preceding embodiments, further comprising detecting, in the second dataset, a new data shift from the first dataset used to train the first machine learning model, determining that a new magnitude of the new data shift does not satisfy the first threshold, and based on determining that the new magnitude of the new data shift does not satisfy the first threshold, refraining from implementing a training routine.
17. The method of any one of the preceding embodiments, wherein performing the first training routine comprises assigning first weights to the second dataset and the synthetic data and assigning second weights to the first dataset, wherein the first weights are heavier than the second weights.
18. The method of any one of the preceding embodiments, further comprising calculating the magnitude of the data shift using feature similarity scores based on the first dataset and the second dataset.
19. The method of any one of the preceding embodiments, further comprising calculating the magnitude of the data shift by comparing one or more predictions generated by the first machine learning model with one or more ground truths derived from the first dataset.
20. The method of any one of the preceding embodiments, further comprising calculating the magnitude of the data shift using one or more evaluation metrics associated with the first machine learning model.
21. One or more tangible, non-transitory, machine-readable media storing instructions that, when executed by one or more data processing apparatuses, cause operations comprising those of any of embodiments 1-20.
22. A system comprising one or more processors; and memory storing instructions that, when executed by the processors, cause the processors to effectuate operations comprising those of any of embodiments 1-20.
23. A system comprising means for performing any of embodiments 1-20.
24. A system comprising cloud-based circuitry for performing any of embodiments 1-20.

What is claimed is:

1. A system for reducing compute resource usage for model training related to data shifts by excluding synthetic data from training datasets that is not representative of the data shifts, the system comprising:
one or more processors and one or more non-transitory computer-readable media having computer-executable instructions stored thereon, the computer-executable instructions, when executed by the one or more processors, causing operations comprising:
detecting, in a production dataset, a data shift from a training dataset used to train a machine learning model;
providing, to a first generative adversarial classifier, the training dataset to train the first generative adversarial classifier to classify whether data belongs to the training dataset;
providing, to a second generative adversarial classifier, the production dataset to train the second generative adversarial classifier to classify whether data belongs to a subset of the production dataset that corresponds to the data shift;
providing, to a generative adversarial generator, the production dataset to cause the generative adversarial generator to generate synthetic data for potential inclusion in an updated training dataset for training the machine learning model;
providing, to the first generative adversarial classifier and the second generative adversarial classifier, the synthetic data to cause the first generative adversarial classifier and the second generative adversarial classifier to classify the synthetic data;
in response to the first generative adversarial classifier indicating that the synthetic data belongs to the training dataset and the second generative adversarial classifier indicating that the synthetic data belongs to the subset corresponding to the data shift, excluding the synthetic data from the updated training dataset; and
in connection with detecting the data shift in the production dataset, updating the machine learning model using the updated training dataset that excludes the synthetic data generated via the generative adversarial generator.

2. A method comprising:
detecting, in a production dataset, a data shift from a training dataset used to train a machine learning model;
providing, to a generative adversarial network comprising a first classifier and a second classifier, the training dataset to train the first classifier and the production dataset to train the second classifier;
providing, to the generative adversarial network, synthetic data derived from the production dataset to cause the first classifier and the second classifier to classify the synthetic data;
receiving, from the generative adversarial network, a first classification for the synthetic data from the first classifier and from the second classifier; and
in response to receiving the first classification for the synthetic data from the first classifier and from the second classifier, excluding the synthetic data from an updated training dataset for updating the machine learning model.

3. The method of claim 2, further comprising:
providing, to the generative adversarial network, other synthetic data derived from the production dataset to cause the first classifier and the second classifier to classify the other synthetic data;
receiving, from the generative adversarial network, the first classification for the other synthetic data from the first classifier and a second classification for the other synthetic data from the second classifier; and
in response to receiving the first classification from the first classifier and the second classification from the second classifier, excluding the other synthetic data from the updated training dataset.

4. The method of claim 2, further comprising:
providing, to the generative adversarial network, other synthetic data derived from the production dataset to cause the first classifier and the second classifier to classify the other synthetic data;
receiving, from the generative adversarial network, a second classification for the other synthetic data from the first classifier and the first classification for the other synthetic data from the second classifier; and
in response to receiving the second classification from the first classifier and the first classification from the second classifier, including the other synthetic data in the updated training dataset.

5. The method of claim 2, further comprising:
providing, to the generative adversarial network, other synthetic data derived from the production dataset to cause the first classifier and the second classifier to classify the other synthetic data;
receiving, from the generative adversarial network, a second classification for the other synthetic data from the first classifier and from the second classifier; and
in response to receiving the second classification from the first classifier and from the second classifier, excluding the other synthetic data from the updated training dataset.

6. The method of claim 2, further comprising providing, to the machine learning model, the updated training dataset to cause the machine learning model to update.

7. The method of claim 6, wherein causing the machine learning model to update comprises causing the machine learning model to update one or more weights used to generate predictions.

8. The method of claim 2, further comprising providing, to a new machine learning model, the updated training dataset to train the new machine learning model to generate predictions.

9. The method of claim 2, further comprising providing, to a new machine learning model, the training dataset and the updated training dataset to train the new machine learning model to generate predictions, wherein the updated training dataset is weighted more heavily than the training dataset.

10. The method of claim 2, wherein the first classification from a classifier indicates that the synthetic data belongs to a dataset on which the classifier is trained and a second classification from the classifier indicates that the synthetic data does not belong to the dataset on which the classifier is trained.

11. The method of claim 2, further comprising providing, to the generative adversarial network, the production dataset to cause the generative adversarial network to derive the synthetic data from the production dataset.

12. One or more non-transitory, computer-readable media storing instructions that, when executed by one or more processors, cause operations comprising:
detecting, in a second dataset, a data shift from a first dataset used to train a machine learning model;
providing, to a generative adversarial network comprising a first classifier and a second classifier, the first dataset to train the first classifier and the second dataset to train the second classifier;
obtaining, via the first classifier and the second classifier, a first classification of synthetic data derived from the second dataset; and
in response to obtaining the first classification via the first classifier and the second classifier, excluding the synthetic data from an updated first dataset for updating the machine learning model.

13. The one or more non-transitory, computer-readable media of claim 12, wherein the instructions further cause the one or more processors to perform operations comprising:
providing, to the generative adversarial network, other synthetic data derived from the second dataset to cause the first classifier and the second classifier to classify the other synthetic data;
receiving, from the generative adversarial network, the first classification for the other synthetic data from the first classifier and a second classification for the other synthetic data from the second classifier; and
in response to receiving the first classification from the first classifier and the second classification from the second classifier, excluding the other synthetic data from the updated first dataset.

14. The one or more non-transitory, computer-readable media of claim 12, wherein the instructions further cause the one or more processors to perform operations comprising:
providing, to the generative adversarial network, other synthetic data derived from the second dataset to cause the first classifier and the second classifier to classify the other synthetic data;
receiving, from the generative adversarial network, a second classification for the other synthetic data from the first classifier and the first classification for the other synthetic data from the second classifier; and
in response to receiving the second classification from the first classifier and the first classification from the second classifier, including the other synthetic data in the updated first dataset.

15. The one or more non-transitory, computer-readable media of claim 12, wherein the instructions further cause the one or more processors to perform operations comprising:
providing, to the generative adversarial network, other synthetic data derived from the second dataset to cause the first classifier and the second classifier to classify the other synthetic data;
receiving, from the generative adversarial network, a second classification for the other synthetic data from the first classifier and from the second classifier; and
in response to receiving the second classification from the first classifier and from the second classifier, excluding the other synthetic data from the updated first dataset.

16. The one or more non-transitory, computer-readable media of claim 12, wherein the instructions further cause the one or more processors to perform operations comprising providing, to the machine learning model, the updated first dataset to cause the machine learning model to update.

17. The one or more non-transitory, computer-readable media of claim 16, wherein, to cause the machine learning model to update, the instructions further cause the one or more processors to cause the machine learning model to update one or more weights used to generate predictions.

18. The one or more non-transitory, computer-readable media of claim 12, wherein the instructions further cause the one or more processors to perform operations comprising providing, to a new machine learning model, the updated first dataset to train the new machine learning model to generate predictions.

19. The one or more non-transitory, computer-readable media of claim 12, wherein the instructions further cause the one or more processors to perform operations comprising providing, to a new machine learning model, the first dataset and the updated first dataset to train the new machine learning model to generate predictions, wherein the updated first dataset is weighted more heavily than the first dataset.

20. The one or more non-transitory, computer-readable media of claim 12, wherein the instructions further cause the one or more processors to perform operations comprising providing, to the generative adversarial network, the second dataset to cause the generative adversarial network to derive the synthetic data from the second dataset.
